(19) United States
(12) Patent Application Publication
(10) Pub. No.: US 2024/0333696 A1
(43) Pub. Date: Oct. 3, 2024

(54) CONTROLLING WRITE ACCESS FOR INPUT/OUTPUT CHANNELS IN AN INDUSTRIAL PROCESS AUTOMATION ENVIRONMENT

(71) Applicant: Yokogawa Electric Corporation, Tokyo (JP)

(72) Inventor: Patrick Clay, Frisco, TX (US)

(21) Appl. No.: 18/128,886

(22) Filed: Mar. 30, 2023

(51) Int. Cl. H04L 9/40; G06F 13/20

(52) U.S. Cl. CPC H04L 63/08; G06F 13/20; G06F 2213/40

(57) ABSTRACT

Implementations are described herein for determining whether to allow a cross-platform process automation client to write to an I/O channel controlled by a cross-platform process automation server. In various implementations, the cross-platform process automation client transmits a request to access a writer account of the cross-platform process automation server to the cross-platform process automation server, to write to the I/O channel. In response to receiving the request to access the writer account, the cross-platform process automation server determines whether the writer account is available. If the writer account is determined as being unavailable (e.g., currently being used by another cross-platform process automation client), the cross-platform process automation server can deny the request from the cross-platform process automation client to access the writer account, and/or provide the cross-platform process automation client access to a reader account.

### BACKGROUND

Process automation facilities may include distributed control nodes (DCNs). Many DCNs have physical input and output (I/O) channels in the form of sensor and actuators, etc. A DCN may host a server that provides read and write access to such I/O channels via user accounts. The user accounts can include one or more reader user accounts that are permitted to read values from the I/O channels. Alternatively or additionally, the user accounts can include one or more writer user accounts which can read from input channels as well as output channels, and write to output channels (e.g., actuators). In some situations, different user accounts can be assigned different roles by the server, and the roles can be assigned read/write permissions for the I/O channels under the server's control.

### SUMMARY

While multiple reader user accounts likely can safely read from an I/O channel, multiple writer user accounts writing to an output channel may cause an actuator of the output channel to receive conflicting or confusing control signals. This may result in the actuator behaving erratically or unpredictably. This can negatively impact any process control loop(s) that include the actuator. Other output channels may be used to provide data to downstream process(es), e.g., hosted at other DCN(s). Multiple writer user accounts writing to these other output channels may result in conflicting and/or unpredictable data being provided to the downstream process(es). This may also negatively impact any process control loop(s) controlled by the downstream process(es).

Implementations of the present disclosure provide permission for a single, active writer user account to access a given output channel (e.g., an actuator within a process automation facility) of a distributed control node (DCN) hosted by a server, e.g., by limiting the server to a single writer user account at once, or by limiting write access to the given output channel to a single writer user account at any time. By limiting the write access in this way, the risk of shared output channels receiving conflicting commands and/or experiencing race conditions can be avoided or reduced.

In various implementations, a method may be implemented using one or more processors and may include: receiving, from a cross-platform process automation client, a request to access a writer account of a cross-platform process automation server to write to an input/output (I/O) channel to which access is controlled by the cross-platform process automation server; and in response to receiving the request to access the writer account of the cross-platform process automation server, determining whether the writer account is available (e.g., free to use). In response to determining that the writer account is unavailable (e.g., in use), the method may further include: denying the request from the cross-platform process automation client to access the writer account of the cross-platform process automation server, and providing the cross-platform process automation client access to a reader account of the cross-platform process automation server.

The writer account, for instance, can be accessible by different cross-platform process automation clients (e.g., that belong to different platforms) using different login credentials at different times. As a working example, suppose a first cross-platform process automation client accesses the writer account using first login credentials at a first point of time T1. Suppose also that a second cross-platform process automation client different from the first cross-platform process automation client accesses the writer account using second login credentials (different from the first login credentials) at a second point of time T2. In this working example, if T2 is sufficiently distant temporally from T1, the first cross-platform process automation client may access the writer account of the cross-platform process automation server, e.g., to write a first controlling signal (e.g., for a clockwise control) to an output channel (e.g., actuator) of a DCN that hosts the cross-platform process automation server. In that case, the output channel may be controlled by the first controlling signal instantly. The second cross-platform process automation client may safely access the writer account of the cross-platform process automation server at T2, e.g., to write a second controlling signal (e.g., for an anti-clockwise control) to the output channel (e.g., actuator) of the DCN that hosts the cross-platform process automation server. The output channel may be controlled by the second controlling signal instantly in response to receiving the second controlling signal.

However, if T2 is too close temporally to (e.g., approximately the same as) T1, implementations of the present disclosure may allow one and only one client among the first and second cross-platform process automation clients (and/or other clients if there are any) to access the writer account. Continuing with the working example, if the cross-platform process automation server receives a request to access the writer account from the first cross-platform process automation client prior to receiving a request to access the writer account from the second cross-platform process automation client (and/or any additional client), the first cross-platform process automation client may be granted access to the writer account while the second cross-platform process automation client (and any additional client if there is any) is not granted access to the writer account. As another non-limiting example, the first cross-platform process automation client may be recognized to have (e.g., be labeled with) a higher priority than other cross-platform process automation client(s) such as the second cross-platform process automation client, and correspondingly, the first cross-platform process automation client may be granted access to the writer account while the second cross-platform process automation client (and any additional client if there is any) is not granted access to the writer account.

Continuing with the working example, the second cross-platform process automation client (and any additional client if there is any) may be granted access to, or assigned, a reader account associated with the cross-platform process automation server. After being granted access to the reader account, the second cross-platform process automation client (and/or any additional client if there is any) may read from one or more I/O channels (including the output channel, e.g., actuator) controlled by the cross-platform process automation server.

In other words, subsequent to authenticating the cross-platform process automation client to access the reader account of the cross-platform process automation server, the method may further include: reading, by the cross-platform process automation client and via the cross-platform process automation server, from the I/O channel.

In some implementations, the cross-platform process automation server can be an Open Platform Communications (OPC) Unified Architecture (UA) server, and the cross-platform process automation client is an OPC UA client in communication with the OPC UA server (e.g., via one or more networks). In some implementations, an I/O channel can correspond to (e.g., be operably coupled with) a sensor, or actuator, or other applicable component of a distributed control node (DCN) that hosts the UPC UA server. The DCN can include any number of I/O channels.

In some implementations, determining whether the writer account is available includes: determining whether a writer semaphore is locked or unlocked. In these implementations, if the writer semaphore is determined as being locked, the writer account can be determined as being unavailable or “in use.” If the writer semaphore is determined as being unlocked or released, on the other hand, the writer account can be determined as being available or free.

In various implementations, the method may further include: in response to determining that the writer account is available, retrieving login credentials to access the writer account of the cross-platform process automation server; and authenticating, based on the login credentials, the cross-platform process automation client to access the writer account of the cross-platform process automation server. In some implementations, the aforementioned request can include the login credentials received by the cross-platform process automation server from the cross-platform process automation client, to access the writer account of the cross-platform process automation server. In various implementations, the method may further include: receiving, from the cross-platform process automation client, input to be written to the I/O channel; and writing to the I/O channel based on the input received from the cross-platform process automation client. The input, for instance, can include a controlling signal to control the I/O channel. In some implementations, optionally, the I/O channel can be controlled by the controlling signal immediately upon receiving the controlling signal.

In various implementations, the method may further include: detecting a disconnection between the cross-platform process automation client and the writer account of the cross-platform process automation server. In these implementations, in response to detecting the disconnection between the cross-platform process automation client and the writer account of the cross-platform process automation server, the method may further include: determining that the writer account of the cross-platform process automation server becomes available. In some implementations, determining that the writer account of the cross-platform process automation server becomes available can be based on determining that the writer semaphore is released, which means the writer semaphore is unlocked.

In various implementations, the method may further include: subscribing the cross-platform process automation client to the writer semaphore to receive a notification when the writer semaphore is released/unlocked. By subscribing to the writer semaphore, the cross-platform process automation client may timely receive a notification that the writer semaphore is released/unlocked (indicating that the writer account becomes available). In response to receiving the notification indicating that the writer account becomes available, the cross-platform process automation client may re-send the request to access the writer account to the cross-platform process automation server, in order to write to the I/O channel.

In addition, some implementations include one or more processors of one or more computing devices, where the one or more processors are operable to execute instructions stored in associated memory, and where the instructions are configured to cause performance of any of the aforementioned methods. Some implementations also include one or more non-transitory computer readable storage media storing computer instructions executable by one or more processors to perform any of the aforementioned methods.

In another aspect, a system may include one or more processors and memory storing instructions that, in response to execution by the one or more processors, cause the one or more processors to: receive, from a cross-platform process automation client, a request to access a writer account of a cross-platform process automation server to write to an input/output (I/O) channel coupled to, and operably controlled by, the process automation server; and determine whether the writer account is available, in response to receiving the request to access the writer account of the cross-platform process automation server.

In various implementations, the system may further include instructions to: deny the request from the user to access the writer account of the cross-platform process automation server and/or provide the cross-platform process automation client access to a reader account of the cross-platform process automation server, in response to determining that the writer account is unavailable.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 schematically depicts an environment in which selected aspects of the present disclosure may be implemented, in accordance with various embodiments.

FIG. 2 schematically depicts an example of how techniques described herein may be implemented, in accordance with various embodiments.

FIG. 3 illustrates an example method for performing selected aspects of the present disclosure.

FIG. 4 schematically illustrates an example computer architecture on which selected aspects of the present disclosure may be implemented.

### DETAILED DESCRIPTION

Implementations described herein pertain to managing access to shared input/output (I/O) channels, such as sensors, actuators, and/or other components, for a process automation facility. In various implementations, a single, active writer user account is permitted to write to a given output channel (e.g., an actuator within the process automation facility) of a distributed control node (DCN) that hosts a server. In some implementations, the server is limited to a single writer user account at once. In some implementations, write access to the given channel is limited to a single writer user account, if multiple writer user account requests to write to the given channel are received. By limiting the write access, the risk of shared output channels receiving conflicting commands and/or experiencing race conditions can be avoided or reduced.

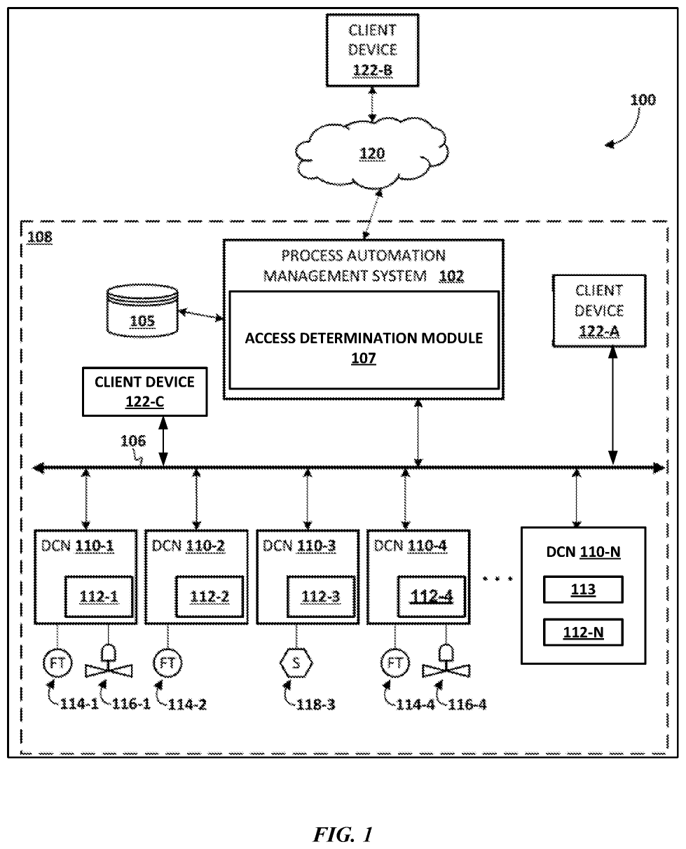

Referring now to FIG. 1, an example environment 100 in which various aspects of the present disclosure may be implemented is depicted schematically. A process automation management system 102 is operably coupled with a process automation network 106 in a process automation facility 108. The process automation facility 108 may take numerous forms and may be designed to implement any number of at least partially automated processes. For example, the process automation facility 108 may take the form of a chemical processing plant, an oil or natural gas refinery, a catalyst factory, a manufacturing facility, an offshore oil platform, etc.

The process automation network 106 may be implemented using various wired and/or wireless communication technologies, including but not limited to the Institute of Electrical and Electronics Engineers (IEEE) 802.3 standard (Ethernet), IEEE 802.11 (Wi-Fi), cellular networks such as 3GPP Long Term Evolution (“LTE”) or other wireless protocols that are designated as 3G, 4G, 5G, and beyond, and/or other types of communication networks of various types of topologies (e.g., mesh). Process automation is often employed in scenarios in which the cost of failure tends to be large, both in human safety and financial cost to stakeholders. Accordingly, in various implementations, the process automation network 106 may be configured with redundancies and/or backups to provide high availability (HA) and/or high quality of service (QoS).

The process automation management system 102 may be connected to a plurality of client devices. For example, the process automation management system 102 can be connected to one or more local client devices (e.g., 122-A and 122-C), and/or be connected to one or more remote client devices (e.g., 122-B). The local client device 122-A or 122-C can be connected to the process automation management system 102 via one or more local area networks (e.g., the process automation network 106), and the remote client device 122-B can be connected to the process automation management system 102 via one or more wide area networks 120 (e.g., the Internet). The local client device(s) and the remote client device(s) may be operable by personnel such as system integrators to configured and/or interact with various aspects of the process automation management system 102.

In some implementations, the process automation management system 102 may include an access determination module 107 and a database 105 that stores information used by the access determination module 107 to practice selected aspects of the present disclosure. Various aspects of the process automation management system 102, such as the access determination module 107, may be implemented using any combination of hardware and software. In some implementations, the process automation management system 102 may be implemented across multiple computer systems as part of what is often referred to as a “cloud infrastructure” or simply the “cloud.” However, this is not required, and in FIG. 1, for instance, the process automation management system 102 is implemented within process automation facility 108, e.g., in a single building or across a single campus of buildings or other industrial infrastructure. In such an implementation, the process automation management system 102 may be implemented on one or more local computing systems, such as on one or more server computers.

In addition to the process automation management system 102, a variety of nodes (e.g., one or more DCNs) can be operably coupled with the process automation network 106. In FIG. 1, for instance, N (positive integer) DCNs (first DCN 110-1, second DCN 110-2, . . . , and Nth DCN 110-N) are operably coupled with the process automation network 106. Each DCN 110 may host a corresponding cross-platform process automation server 112-1, 112-2, . . . , or 112-N. Each DCN 110 may also include circuitry and/or logic (not depicted) that may take various forms, such as processor(s) that execute instructions in memory, a field-programmable gate array (FPGA), an application-specific integrated circuit (ASIC), and so forth.

Each DCN (e.g., 110-1) may have a particular role to play in the process automation network 106. “Compute” DCNs may, for instance, control a process loop (e.g., a chemical process loop) in which various “field” devices (e.g., devices having sensors and/or actuators) interface with each other to perform some number of function control blocks (FBs). In some implementations, a software component implemented on the any DCN mentioned herein may transform an analog signal to digital; and/or convert the signal between different units of measurement, for instance. In addition, in some implementations, a software component implemented on a DCN 110 may be configured to translate data between various protocols. For example, a particular vendor's DCN (or other legacy device) may not be configured natively to communicate data using the OPC Unified Architecture (OPC UA). In some such implementations, another DCN 110 may be deployed to translate this data from the vendor's proprietary format to OPC UA. Some such DCNs 110 may be referred to as “gateways” or “bridges” because they form a link between legacy technology and standards such as OPC UA.

Each DCN may have one or more input/output (I/O) components, which are accessible as “channels,” and which dictate at least some of its operational technology (OT) capabilities and, more generally, its role at the process automation facility 108. For example, the first DCN 110-1 includes a flow transmitter (FT) component 114-1 (as an input channel) and an actuator (e.g., a valve) 116-1 (as an output channel).

Actuator 116-1 (and other actuators described herein) may be any electric, hydraulic, mechanical, and/or pneumatic component that is controllable to affect some aspect of a process automation workflow that occurs at the process automation facility 108. For example, first DCN 110-1 may operate actuator 116-1 to perform its function in response to various signals, such as sensor signals or commands. Some non-limiting examples of actuators 116 include, but are not limited to, valves, pistons, rotors, switches, heaters, coolers, stirrers, injectors, devices to create vacuums, belts, tracks, gears, grippers, motors, relays, servomechanisms, etc.

Each DCN 110 may have different OT capabilities with respect to one or more (e.g., all) other DCNs 110. In FIG. 1, for instance, second DCN 110-2 includes a FT component 114-2 but no actuator. Third DCN 110-3 includes a sensor 118-3 but no actuator. Sensor 118-3 (and other sensors mentioned herein) may take various forms, including but not limited to a pressure sensor, a temperature sensor, a flow sensor (e.g., FT component 114), various types of proximity sensors, a light sensor (e.g., a photodiode), a pressure wave sensor (e.g., microphone), a humidity sensor (e.g., a humistor), a radiation dosimeter, a laser absorption spectrograph (e.g., a multi-pass optical cell), and so forth. Like first DCN 110-1, fourth DCN 110-4 also includes both a FT component 114-4 and an actuator 116-4.

Unlike DCNs 110-1 to 110-4, the Nth DCN 110-N does not include any input/output (actuators or sensors) components. Instead, DCN 110-N may be a “compute only” DCN whose role is to facilitate cooperation between itself and one or more other DCNs 110 on process automation network 106 to implement an at least partially automated process. For example, the Nth DCN 110-N may control a single process loop (e.g., a chemical process control loop) that involves one or more other DCNs 110. In some cases, the compute DCN (e.g., the Nth DCN 110-N) may perform a role similar to an autopilot on an airplane—the compute DCN may receive various signals and, based on those signals and various criteria and/or thresholds, control various actuators. For example, the compute DCN may monitor various sensors (e.g., the sensor 118-3) to ascertain data about chemical levels, flow rates (e.g., across valves), tank temperatures, control rates, etc., and may control one or more actuators (e.g., actuator 116-1 and/or actuator 116-4) based on these data and/or comparisons of these data to various criteria and/or thresholds. For instance, the compute DCN (e.g., 110-N) can control the actuator 116-4 by transmitting, to the fourth DCN 110-4, corresponding command(s) that can optionally conform to a protocol that is specific to the fourth DCN 110-4.

Many DCNs may have multiple physical I/O components, and hence, multiple I/O channels that can be accessed, e.g., by other devices or systems such as other DCNs, the access determination module 107, etc. To control access to these I/O channels, each DCN 110 may host a cross-platform process automation server, such as an OPC UA server, that provides access to various data resources of the DCN 110, including, e.g., the DCN's I/O channels. A client application, which can be a “cross-platform process automation client” such as an OPC UA client (e.g., 113 executing on the Nth DCN 110-N) operating on a DCN 110, may connect to a cross-platform process automation server (e.g., OPC UA server 112-1) hosted by the corresponding DCN (e.g., 110-1) so that it can read data from input channels associated with, for instance, sensors such as the FT component 114-1, etc. Likewise, the client application (e.g., the OPC UA client 113) may connect to the server (e.g., OPC UA server 112-1) hosted by the DCN (e.g., 110-1) to write data to output channels, e.g., to provide control signals or commands to an actuator such as the actuator 116-1. While not depicted in FIG. 1, any of DCNs 110-1 to 110-N-1 may also host their own OPC UA clients alongside their respective OPC UA servers 112-1 to 112-N-1.

As an example, a OPC UA server (e.g., 112-1) executing on the first DCN 110-1 may be reachable, e.g., by an OPC UA client, using the following connection string: opc.tcp://10.0.1.1:48010. In this example, the characters “opc.tcp” may specify a connection protocol to be used. The numbers “10.0.1.1” may be an IP address of the first DCN 110-1 executing the OPC UA server 112-1. The numbers “48010” may be the TCP port to which the OPC UA server 112-1 is listening and accepting connections. This OPC UA server 112-1 may in turn provide access to I/O channels or other data associated with the first DCN 110-1 (e.g., sensor readings stored in memory, results of calculations, semaphore values, etc.). Each of the I/O channels may be referenced using a Node ID. As a non-limiting example, the actuator 116-1 can be referenced using the following Node ID: ns=5;i=5242.

In some circumstances, multiple OPC UA clients (e.g., 113) may attempt to read from an input channel (e.g., the FT component 114-1) of a DCN (e.g., the first DCN 110-1) at the same time by connecting to a server (e.g., the server 112-1) executing on the DCN and/or referencing the input channel with a Node ID for the input channel. In some circumstances, multiple OPC UA clients may attempt to write to an output channel (e.g., the actuator 116-1) of a DCN (e.g., the first DCN 110-1) at the same time by connecting to a server (e.g., the server 112-1) executing on the DCN and/or referencing the output channel with a Node ID for the output channel.

In the above circumstances, while multiple OPC UA clients likely can safely read from the input channel at the same time, multiple OPC UA clients writing to the output channel (e.g., the actuator 116-1) at the same time can cause the output channel to receive conflicting or confusing control signals, which causes the output channel to behave erratically or unpredictably. This can negatively impact any process control loop(s) that include the actuator. To avoid or reduce the risk of the output channel receiving conflicting control signals at the same time, implementations of the present disclosure provide components such as the individual OPC UA servers 112-1 to 112-N and/or the access determination module 107 to limit the number of OPC UA clients connected with the OPC UA server as writers to one at any moment. Alternatively, given multiple OPC UA clients writing to a given output channel (e.g., the actuator 116-1) at the same time, the individual OPC UA servers 112-1 to 112-N and/or access determination module 107 can limit write access to the given output channel to a single OPC UA client, out of the multiple OPC UA clients.

As a non-limiting example, an individual OPC UA server 112 and/or access determination module 107 can authorize, among multiple OPC UA clients attempting to write to a given output channel of a DCN on which an OPC UA server is executed, the OPC UA client first connecting to the OPC UA server. In this example, the individual OPC UA server 112 and/or access determination module 107 can reject connection of the OPC UA server with the rest of OPC UA clients other than the OPC UA client first connecting to the OPC UA server. The individual OPC UA server 112 and/or access determination module 107 can further authorize the OPC UA client first connecting to the OPC UA server to write to the given output channel.

As another non-limiting example, the individual OPC UA server 112 and/or access determination module 107 can permit all OPC UA clients, of the multiple OPC UA clients attempting to write to a given output channel of a DCN on which an OPC UA server is executed, to be connected with the OPC UA server. The access determination module 107 can then authorize and only authorize an OPC UA client first connecting to the OPC UA server, to write to the given output channel.

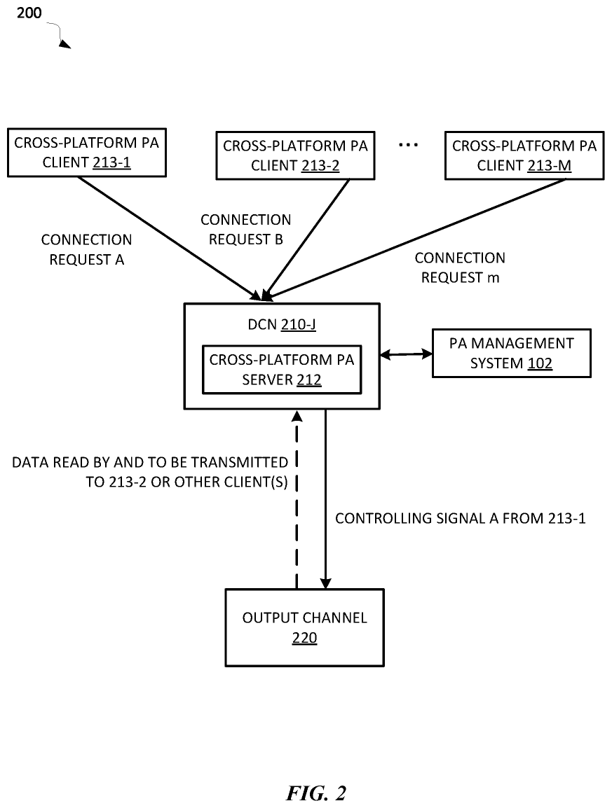

FIG. 2 schematically depicts an example of how techniques described herein may be implemented, in accordance with various embodiments. As shown in FIG. 2, a plurality of cross-platform process automation (PA) clients 213-1, 213-2, . . . 213-M can each and respectively send a write request to a cross-platform PA server 212, to write to an output channel 220 of a DCN 210-J that hosts the cross-platform PA server 212. The plurality of cross-platform PA clients can include, for example, a first cross-platform PA client 213-1 that attempts to connect to the cross-platform PA server 212 with a connection request A (e.g., a writer user account connection request) at t_1, to write to the output channel 220 (e.g., a controlling signal A to control the output channel 220 approximately at a given moment T).

The plurality of cross-platform PA clients can further include, for example, a second cross-platform PA client 213-2 that attempts to connect to the cross-platform PA server 212 at t_2 (subsequent to t_1) with a connection request B, to write to the output channel 220 (e.g., a controlling signal B to control the output channel 220 approximately at the given moment T). The plurality of cross-platform PA clients can further include, for example, a M^{th} cross-platform PA client 213-M that attempts to connect to the cross-platform PA server 212 at t_m (also subsequent to t_1) with connection request m, to write to the output channel 220 (e.g., a controlling signal m to control the output channel 220 approximately at the given moment T).

The cross-platform PA server 212 can either consult its local records, or access the aforementioned PA management system 102, to select and/or authorize one of the plurality of cross-platform PA clients to write to the output channel 220. For example, the cross-platform PA server 212 can be limited, e.g., by the PA management system 102, to run a single, active writer user account at a given moment, where the single, active writer user account can be accessed by different cross-platform PA clients (e.g., using different login credentials) at different points of time.

Continuing with the example above, if the first cross-platform PA client 213-1 transmits the connection request A to access a writer account (e.g., a writer account associated with the cross-platform PA server 212) to the cross-platform PA server 212 earlier than any other connection request (e.g., connection request B, . . . , connection request m) from other cross-platform PA clients (e.g., 213-2, . . . , 213-M), the PA management system 102 can determine that the first cross-platform PA client 213-1 shall access the writer account associated with the cross-platform PA server 212. In response to the PA management system 102 determining that the first cross-platform PA client 213-1 shall access the writer account associated with the cross-platform PA server 212, the cross-platform PA client 213-1 can be connected with the first cross-platform PA server 212, for the first cross-platform PA client 213-1 to access the writer account (e.g., the single writer account that the cross-platform PA server 212 has), to write to the output channel 212 (e.g., with a controlling signal A).

Continuing with the above example, the cross-platform PA server 212 and/or PA management system 102 can determine that all cross-platform PA clients other than the first cross-platform PA client 213-1 shall have no access to the writer account associated with the cross-platform PA server 212. In some implementations, the PA management system 102 or the cross-platform PA server 212 can reject the corresponding connection requests (e.g., connection request B, . . . , and connection request m) by rejecting their access to the writer account, or by rejecting connection of these cross-platform PA clients to the cross-platform PA server 212. In some implementations, in response to the cross-platform PA server 212 and/or PA management system 102 determining that all cross-platform PA clients 213-2, . . . , 213-M other than the first cross-platform PA client 213-1 shall have no access to the writer account associated with the cross-platform PA server 212, these cross-platform PA clients 213-2, . . . , 213-M can each be granted with a respective reader account to read from one or more additional I/O channels of the DCN 210-J.

In other words, in some implementations, the cross-platform PA server 212 and/or PA management system 102 can authorize one and only one writer account at a given moment for a cross-platform PA client to write to one or more output channels of the DCN 210-J (e.g., based on node IDs), while authorizing a plurality of reader accounts for different cross-platform PA clients to read data from a given I/O channel of the DCN 210-J at the same time (see, e.g., the dashed line in FIG. 2).

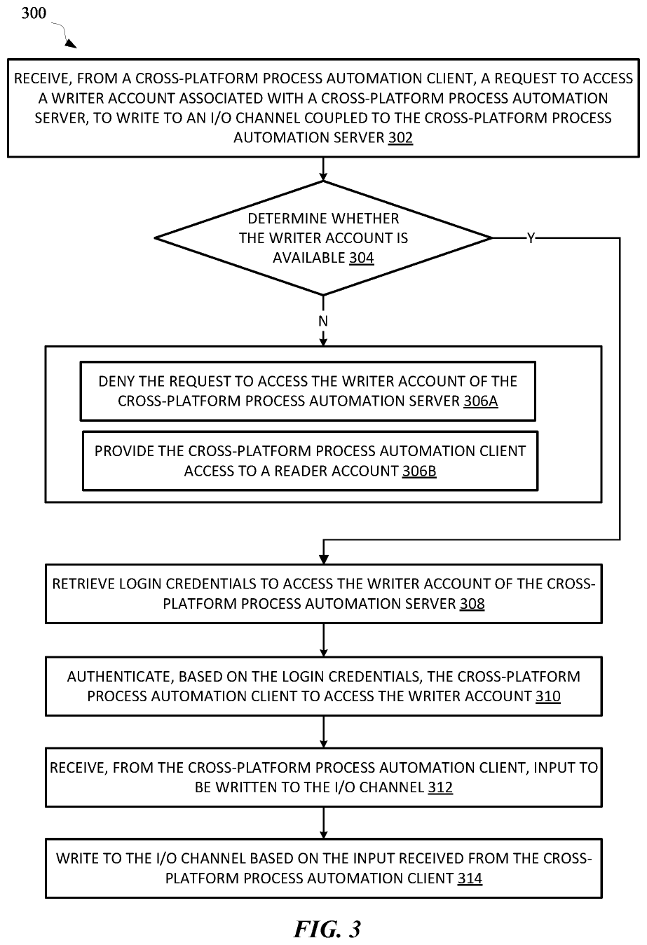

FIG. 3 is a flowchart illustrating an example method 300 of practicing selected aspects of the present disclosure, in accordance with implementations disclosed herein. For convenience, the operations of the flow chart are described with reference to a system that performs the operations. This system may include various components of various computer systems, such as one or more components of process automation (PA) management system 102, including the access determination module 107 and/or the database 105, and/or one or more components of one or more DCNs, including a cross-platform PA server (e.g., 112, 212). Moreover, while operations of method 300 are shown in a particular order, this is not meant to be limiting. One or more operations may be reordered, omitted or added.

At block 302, the system, e.g., by way of a cross-platform process automation server such as the server 112-1, may receive, from a cross-platform process automation client (e.g., running automatically on the same or different DCN, or on a client device such as 122-A that may or may not be operated by person), a request to access a writer account associated with the cross-platform process automation server to write to an I/O channel controlled by the cross-platform process automation server. The cross-platform process automation client can be, for instance, an OPA UA client hosted by a DCN in a process automation facility. The cross-platform process automation server can be, for instance, an OPA UA server (e.g., 112) hosted by another DCN in the process automation facility 108.

At block 304, the system, e.g., by way of the cross-platform PA server 212 and/or access determination module 107, may determine whether the writer account is available. For example, the system can determine whether the writer account associated with the cross-platform process automation server is currently being used. If the system determines that the writer account is currently being used, the system can determine that the writer account is unavailable. The writer account can be one and the only one active writer account associated with the cross-platform process automation server at a given moment. In other words, the system may allow one and only one active writer account at a given moment to write to I/O channels of a DCN that hosts the cross-platform process automation server. In some implementations, the determination of block 304 includes: determining whether a writer semaphore is locked or unlocked. In these implementations, if the writer semaphore is determined as being locked, the writer account can be determined as being unavailable, and if the writer semaphore is determined as being unlocked, the writer account can be determined as being available.

At block 306A, the system, in response to determining that the writer account is unavailable, may deny the request to access the writer account of the cross-platform process automation server. For instance, the system can generate and forward a message to the cross-platform process automation client, where the message indicates that the writer account is currently unavailable. Optionally, the message may further encourage or solicitate the cross-platform process automation client to re-send the request at a later time.

At block 306B, the system may additionally/optionally provide the cross-platform process automation client access to a reader account associated with the cross-platform process automation server. In some implementations, the system may, in response to determining that the writer account is unavailable, provide the cross-platform process automation client access to a reader account associated with the cross-platform process automation server. For instance, the aforementioned access determination module 107 can create or assign a reader account to the cross-platform process automation client to read from one or more I/O channels of the DCN hosting the cross-platform process automation server.

At block 308, the system may, in response to determining that the writer account is available, retrieve login credentials to access the writer account of the cross-platform process automation server. In some implementations, the login credentials can be included in the request to access the writer account of the cross-platform process automation server.

At block 310, the system may authenticate, based on the login credentials, the cross-platform process automation client to access the writer account of the cross-platform process automation server. As mentioned above, in some implementations, the aforementioned request can include the login credentials received by the cross-platform process automation server from the cross-platform process automation client, to access the writer account of the cross-platform process automation server.

At block 312, the system may receive, from the cross-platform process automation client, input to be written to the I/O channel. The input can be, for instance, a controlling signal to control the I/O channel or other similar signals. For example, the I/O channel can be a valve, and the controlling signal can turn the valve to the right at a given moment (e.g., a current moment). At block 314, the system may write to the I/O channel based on the input received from the cross-platform process automation client. In this case, the I/O channel may be controlled, based on the input (e.g., controlling signal written to the I/O channel).

In various implementations, the system may further detect a disconnection between the cross-platform process automation client and the writer account of the cross-platform process automation server. In these implementations, in response to detecting the disconnection between the cross-platform process automation client and the writer account of the cross-platform process automation server, the system may release the writer semaphore so that the writer semaphore is unlocked.

In various implementations, the system may subscribe a cross-platform process automation client that was denied write access to the writer semaphore to receive a notification when the writer semaphore is released/unlocked. In these implementations, the cross-platform process automation client can be notified of the writer semaphore is unlocked (indicating that the writer account becomes available). The cross-platform process automation client may then re-send the request to the write to the cross-platform process automation server, to access the writer account.

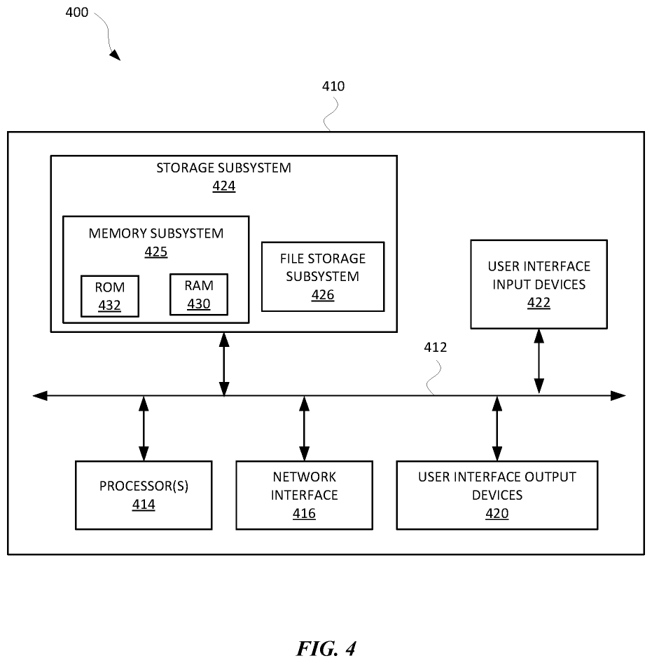

FIG. 4 is a block diagram of an example computing device 410 that may optionally be utilized to perform one or more aspects of techniques described herein. Computing device 410 typically includes at least one processor 414 which communicates with a number of peripheral devices via bus subsystem 412. These peripheral devices may include a storage subsystem 424, including, for example, a memory subsystem 425 and a file storage subsystem 426, user interface output devices 420, user interface input devices 422, and a network interface subsystem 416. The input and output devices allow user interaction with computing device 410. Network interface subsystem 416 provides an interface to outside networks and is coupled to corresponding interface devices in other computing devices.

User interface input devices 422 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 410 or onto a communication network.

User interface output devices 420 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 410 to the user or to another machine or computing device.

Storage subsystem 424 stores programming and data constructs that provide the functionality of some or all of the modules described herein. For example, the storage subsystem 424 may include the logic to perform selected aspects of the methods of FIG. 3, as well as to implement various components depicted in FIGS. 1-2.

These software modules are generally executed by processor 414 alone or in combination with other processors. Memory 425 used in the storage subsystem 424 can include a number of memories including a main random-access memory (RAM) 430 for storage of instructions and data during program execution and a read only memory (ROM) 432 in which fixed instructions are stored. A file storage subsystem 426 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 426 in the storage subsystem 424, or in other machines accessible by the processor(s) 414.

Bus subsystem 412 provides a mechanism for letting the various components and subsystems of computing device 410 communicate with each other as intended. Although bus subsystem 412 is shown schematically as a single bus, alternative implementations of the bus subsystem may use multiple busses.

Computing device 410 can be of varying types including a workstation, server, computing cluster, blade server, server farm, or any other data processing system or computing device. Due to the ever-changing nature of computers and networks, the description of computing device 410 depicted in FIG. 4 is intended only as a specific example for purposes of illustrating some implementations. Many other configurations of computing device 410 are possible having more or fewer components than the computing device depicted in FIG. 4.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A computer-implemented method, comprising:
receiving, from a cross-platform process automation client, a request to access a writer account of a cross-platform process automation server to write to an input/output (I/O) channel to which access is controlled by the cross-platform process automation server;
in response to receiving the request to access the writer account of the cross-platform process automation server, determining whether the writer account is available; and
in response to determining that the writer account is unavailable,
denying the request from the cross-platform process automation client to access the writer account of the cross-platform process automation server, and
providing the cross-platform process automation client access to a reader account of the cross-platform process automation server.

2. The method of claim 1, further comprising:
in response to determining that the writer account is available, retrieving login credentials to access the writer account from the cross-platform process automation client; and
authenticating, based on the retrieved login credentials to access the writer account, the cross-platform process automation client to access the writer account of the cross-platform process automation server.

3. The method of claim 2, further comprising:
detecting a disconnection between the cross-platform process automation client and the writer account of the cross-platform process automation server; and
in response to detecting the disconnection between the cross-platform process automation client and the writer account of the cross-platform process automation server, releasing a writer semaphore so that the writer account becomes available to access for an additional cross-platform process automation client.

4. The method of claim 2, further comprising:
receiving, from the cross-platform process automation client, input to be written to the I/O channel; and
writing to the I/O channel based on the input received from the cross-platform process automation client.

5. The method of claim 1, further comprising:
subscribing the cross-platform process automation client to a writer semaphore to receive a notification when the writer semaphore is released.

6. The method of claim 1, wherein subsequent to authenticating the cross-platform process automation client to access the reader account of the cross-platform process automation server, the method further comprises:
reading, by the cross-platform process automation client and via the cross-platform process automation server, from the I/O channel.

7. The method of claim 1, wherein the cross-platform process automation server is hosted by a Distributed Control Node (DCN) that includes one or more additional I/O channels that are in additional to the I/O channel.

8. The method of claim 1, wherein the request includes login credentials received by the cross-platform process automation server from the cross-platform process automation client, to access the writer account of the cross-platform process automation server.

9. A system, comprising:
a cross-platform process automation client to request access to a writer account of a cross-platform process automation server to write to an input/output (I/O) channel to which access is controlled by the cross-platform process automation server; and
the cross-platform process automation server to receive, from the cross-platform process automation client, the request to access the writer account of the cross-platform process automation server;
wherein the cross-platform process automation server is to determine, in response to receiving the request to access the writer account of the cross-platform process automation server, whether the writer account is free or in use, and
wherein in response to determining that the writer account is in use, the cross-platform process automation server is to:
deny the request from the cross-platform process automation client to access the writer account of the cross-platform process automation server, and
provide the cross-platform process automation client access to a reader account of the cross-platform process automation server.

10. The system of claim 9, wherein:
in response to the writer account being free, the cross-platform process automation server is to:
retrieve, from the cross-platform process automation client, login credentials to access the writer account; and
authenticate, based on the retrieved login credentials to access the writer account, the cross-platform process automation client to access the writer account of the cross-platform process automation server.

11. The system of claim 9, wherein:
in response to the cross-platform process automation server detecting a disconnection between the cross-platform process automation client and the writer account of the cross-platform process automation server, the cross-platform process automation server is to determine that the writer account is free to access for an additional cross-platform process automation client.

12. The system of claim 10, wherein:
the cross-platform process automation server is to receive, from the cross-platform process automation client, input to be written to the I/O channel; and
the cross-platform process automation server is to write to the I/O channel based on the input received from the cross-platform process automation client.

13. The system of claim 9, wherein:
the cross-platform process automation server is to subscribe the cross-platform process automation client to a writer semaphore to receive a notification when the writer account changes from in use to free.

14. The method of claim 1, wherein
subsequent to the cross-platform process automation server authenticating the cross-platform process automation client to access the reader account of the cross-platform process automation server, the cross-platform process automation client is to read from the I/O channel.

15. The method of claim 1, wherein the cross-platform process automation server is hosted by a Distributed Control Node (DCN) that includes one or more additional I/O channels.

16. A cross-platform process automation server comprising one or more processors and memory storing instructions that, when executed, cause the one or more processors to:
receive, from a cross-platform process automation client, a request to access a writer account of a cross-platform process automation server to write to an I/O channel to which access is controlled by the cross-platform process automation server,
in response to the request to access the writer account of the cross-platform process automation server, determine whether the writer account is free or in use; and
in response to the writer account being in use,
deny the request from the cross-platform process automation client to access the writer account of the cross-platform process automation server, and
provide the cross-platform process automation client to access a reader account of the cross-platform process automation server.

17. The cross-platform process automation server of claim 16, further comprising instructions to:
in response to the writer account being free:
retrieve, from the cross-platform process automation client, login credentials to access the writer account; and
authenticate, based on the retrieved login credentials to access the writer account, the cross-platform process automation client to access the writer account of the cross-platform process automation server.

18. The cross-platform process automation server of claim 16, further comprising instructions to:
in response to detecting a disconnection between the cross-platform process automation client and the writer account of the cross-platform process automation server, determine that the writer account is free to access for an additional cross-platform process automation client.

19. The cross-platform process automation server of claim 18, further comprising instructions to:
receive, from the cross-platform process automation client, input to be written to the I/O channel; and
write to the I/O channel based on the input received from the cross-platform process automation client.

20. The cross-platform process automation server of claim 16, wherein the cross-platform process automation server is hosted by a Distributed Control Node (DCN) that includes one or more additional I/O channels.
